(19) United States
(12) Patent Application Publication
(10) Pub. No.: US 2012/0099983 A1
(43) Pub. Date: Apr. 26, 2012

(54) Torque Balanced, Lift Rotor Module, Providing Increased Lift, With Few or No Moving Parts

(76) Inventor: Charles Howard Medlock, Lonoke, AR (US)

(21) Appl. No.: 13/232,789

(22) Filed: Sep. 14, 2011

Related U.S. Application Data
(60) Provisional application No. 61/405,531, filed on Oct. 21, 2010.

(51) Int. Cl. F04D 29/54

(52) U.S. Cl. 415/208.1

(57) ABSTRACT

A device for continuous torque/anti-torque force balance, except for trim adjustments, of the torque requirements of a single lift rotor while lifting varying load weights and with varying power settings, using a relatively short, cylindrical, vertical duct, flared at the top, air entry end, which flare the lift rotor plane of rotation is parallel to and just below, and is closely contained by the relatively short, cylindrical, vertical duct's inside diameter, and just above a fixed pitch, essentially vertical, array of air foil shaped vanes. In this configuration, lateral lift in an anti-torque rotational direction is generated, in direct proportion to the lift rotor torque requirements, by the lift rotor's rotor wash with swirl air flow component forced interaction with the fixed pitch, essentially vertical, array of air foil shaped vanes to continuously balance torque/anti-torque forces.

### RELATED APPLICATIONS

The present application is a continuation application of U.S. provisional patent application, Ser. No. 61405531, filed Oct. 21, 2010, for TORQUE BALANCED, LIFT ROTOR MODULE PROVIDING INCREASED LIFT WITH FEW OR NO MOVING PARTS, by Charles H Medlock, included by reference herein and for which benefit of the priority date is hereby claimed.

### FIELD OF THE INVENTION

The present invention relates to methods of torque balance and control of a single lift rotor and, more particularly, to torque balance and control of a single lift rotor using its rotor wash and swirl component to generate anti-torque, lateral lift within a duct, using a fixed pitch, essentially vertical, array of air foil shaped vanes.

### BACKGROUND OF THE INVENTION

Single rotor aerial cranes, unmanned aerial vehicles, and all other single rotor, rotor craft have to be designed to counter or eliminate and control the torque resulting from a rotating power source rotating a single lift rotor in order to generate lift and stabilize the load being lifted isolating the load from the torque and torque reaction. Without torque control the load or craft being lifted will spin in the opposite direction of the lift rotor since every action causes and equal but opposite reaction, torque force causes a reaction of torque force in the opposite rotational direction. This torque reaction must be constantly balanced with anti-torque force in order to isolate the load from its effects and control lift and horizontal movement or flight.

Torque is present at the center of lift when a single lift rotor, lifting a load, is rotated by a rotary torque power source in order to generate the lift required to lift a load, as in, for instance the main lift rotor drive shaft connecting a rotary torque power source to the main, lift rotor, of a helicopter. The heavier the load, the more lift required; the more lift required, the more torque necessary to turn the rotor and the more anti-torque force required to balance torque. The dynamic of varying load weight and torque power settings when using a lift rotor to lift a load determine the constantly changing amount of torque and requires a constant balance of anti-torque force in order to keep the load under control rotationally. The anti-torque force must constantly be equal to the torque force in order to maintain a horizontal heading and keep the front of the craft or load facing a desired direction. Rotational stability is a necessary ingredient for controlled flight or aerial lifting and placement or delivery of a load using a single lift rotor. Balancing torque requirements with anti-torque has been a challenge from the beginning of single lift rotor, vertical lifting and flight.

Various methods have been developed to accomplish torque control and torque balance including but not limited to contra rotating rotors, tandem, or multiple, counter-rotating rotors, tail rotors, tip jets etc. All these approaches result in a design which is complex, require technical training to use and are expensive to purchase and maintain. Tip jets have proven all but impractical because of problems getting fuel to the tips of a spinning rotor, where the jets or propellers, are located and dealing with the centrifugal forces moving towards the tips. The three most common methods of controlling the torque of a single lift rotor, lifting a load are contra rotating rotors, counter rotating rotors and the tail boom, operating outside the diameter of the main, lift rotor. Contra rotating rotors use a shaft within a shaft in order to spin two lift rotors in opposite directions, thereby canceling one lift rotor's torque with the torque of the other. Contra rotating rotors require technical training, a complicated set of controls and an expensive drive train and transmission. Synchronizing the pitch of the props to transfer air smoothly between the lift rotors and downward in forward movement under varying load and wind conditions requires a lot of skill and or programming and precision controls. Contra rotating propellers have problems at higher speeds, like all lift rotors, because as one lift rotor blade is advancing the other is retreating. This causes unbalanced lift, more lift from the advancing blade and less lift from the retreating blade. Contra rotating lift rotors are actually a safer, better system than the one used more commonly. The most common method of balancing the torque of a single lift rotor is used on most helicopters called the tail boom, most with an open propeller or other means of directing force at a right angle to the shaft turning the main rotor, and operating outside the main lift rotor's rotor wash. The tail boom operates outside of the main rotor's rotor wash and has been used in various configurations, including shrouded rotors, air straightening vanes, variable pitch propellers, directionally ducted exhaust, and in combination with a thruster propeller to help with horizontal thrust. All of these tail boom methods to control torque using a tail boom have drawbacks and are innately inefficient because they all push the load sideway using energy taken away from, and necessarily countered by lift generation. Tail boom torque control uses up to 30% of the total horse power of the craft using it. The third type of torque control is used mainly by the military and isn't actually single rotor torque control. It is counter rotating rotors on different rotating shafts, usually at opposite ends of the craft. This counters the torque but presents new challenges of control as loads vary and wind, mission requirements and terrain conditions are in constant flux.

Helicopters using a tail boom expend up to 30% of the total power of the craft to balance torque and they are very expensive for most individuals to own and maintain and require a lot of training and practice to fly. Tandem, counter rotating rotors located at opposite ends of a craft are very expensive for most individuals to own and maintain and require a lot of training and experience to fly. Contra rotating torque control methods are very expensive for most individuals to own and maintain and are very complicated and require training and experience to gain proficiency.

The most common method of torque control, using a tail boom outside of the main rotor's rotor wash not only uses up to 30% of the total horse power of the helicopter, the tail rotors have caused death and destruction of property by striking the ground, objects or people. Tail boom methods are ineffective to the extent they, by design, push the craft or load sideways as they balance or control the torque of the main rotor because the force they generate originates 12 to 40 feet from the center of the torque they are countering, balancing and controlling. Controlling a helicopter is a complicated process, of balancing lift by constantly changing the pitch of the lift rotor's blades, controlling torque, by changing the speed/pitch of the tail rotor, directing horizontal movement, by changing the center of gravity with the tilt of the main lift rotor. This is especially complicated during hover, landing, and take off. Hovering a helicopter in ground effect, above the ground within the diameter of the rotor, especially over slanted geography, as in a search and rescue can and has caused unbalanced circulation of the rotor wash and unbalanced lift causing the helicopters to roll and crash.

It is therefore an object of the invention to provide a method of maintaining constant balance of the torque requirements of a single lift rotor lifting a load under varying load weights and power settings with anti-torque force.

It is another object of the invention to provide a fail safe method of balancing the torque required to turn a lift rotor while lifting a load under varying load weights and power settings with anti-torque force.

It is another object of the invention to provide a system of balancing the torque required by a single lift rotor while lifting a load and providing increased lift or thrust under varying load weights and power settings.

It is another object of the invention to provide a simple means of balancing the torque requirements of a single lift rotor lifting a load under varying load weights and power settings with anti-torque force.

It is another object of the invention to provide an inexpensive method of balancing the torque requirements of a single lift rotor lifting a load under varying load weights and power settings with anti-torque force.

It is another object of the invention to provide a relatively light weight method of balancing the torque requirements of a single lift rotor lifting a load under varying load weights and power settings with anti-torque force.

It is another object of the invention to provide a method of balancing the torque requirements of a single lift rotor with no moving parts while lifting a load under varying load weights and power settings with anti-torque force.

It is another object of the invention to provide a method of balancing the torque requirements of a single lift rotor while providing 20 to 50% more lift while lifting a load under varying load weights and power settings with anti-torque force.

It is another object of the invention to provide a method of balancing the torque requirements of a single lift rotor that is automatic and fail safe while lifting varying load weights and power settings with anti-torque force.

It is another object of the invention to provide a method of balancing the torque requirements of a single lift rotor with lateral lift anti-torque force while lifting varying load weights and power settings.

It is another object of the invention to provide a method of balancing the torque requirements of a single lift rotor lifting varying load weights and under varying power settings that is modular.

### SUMMARY OF THE INVENTION

In accordance with the present invention, there is provided a method of continuously countering the torque requirements of a single lift rotor lifting a load under varying load weights and power settings with anti-torque, lateral lift, force, except for trim adjustments. The counter-torque, torque balance is achieved through the use of a lift rotor with a rotor wash with a swirl air flow component and with a plane of rotation parallel to, and just above a fixed pitch, essentially vertical, array of air foil shaped vanes, a control mount, and a relatively short, cylindrical, vertical duct, flared at the top, air entry end, below which is the lift rotor plane of rotation. In this configuration, these elements can provide continuous, automatic, absolutely dependable torque/anti-torque force balance of a single lift rotor lifting a load under varying load weights and power settings except for trim adjustments. The configuration requires the relatively short, cylindrical, vertical duct to be of an inside diameter to closely surround the lift rotor diameter of rotation for increased lift and attached to the fixed pitch, essentially vertical, array of airfoil shaped vanes and long enough for a relatively small vertical space between the lift rotor plane of rotation and the fixed pitch, essentially vertical, array of air foil shaped vanes located parallel to and below the lift rotor plane of rotation, near the relatively short, cylindrical, vertical, duct air exit end. An optional method of trim may be required.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top perspective view of a torque balanced, lift rotor module, providing increased lift, with few or no moving parts assembly consisting of a swirl air flow a duct surrounding an array of air foil shaped vanes beneath a lift rotor driven by a lift rotor, drive mechanism and attached to the inside diameter of the duct, below the lift rotor and to a central control mount at the other lengthwise end of each air foil;

FIG. 2 is a bottom perspective view of a torque balanced, lift rotor module, providing increased lift, with few or no moving parts assembly consisting of a swirl air flow a duct surrounding an array of air foil shaped vanes beneath a lift rotor driven by a lift rotor, drive mechanism and attached to the inside diameter of the duct, below the lift rotor and to a central control mount at the other lengthwise end of each air foil; and

FIG. 3 is a top view of a torque balanced, lift rotor module, providing increased lift, with few or no moving parts assembly consisting of a swirl air flow a duct surrounding an array of air foil shaped vanes beneath a lift rotor driven by a lift rotor, drive mechanism and attached to the inside diameter of the duct, below the lift rotor and to a central control mount at the other lengthwise end of each air foil.

For purposes of clarity and brevity, like elements and components will bear the same designations and numbering throughout the Figures.

### DESCRIPTION OF THE PREFERRED EMBODIMENT

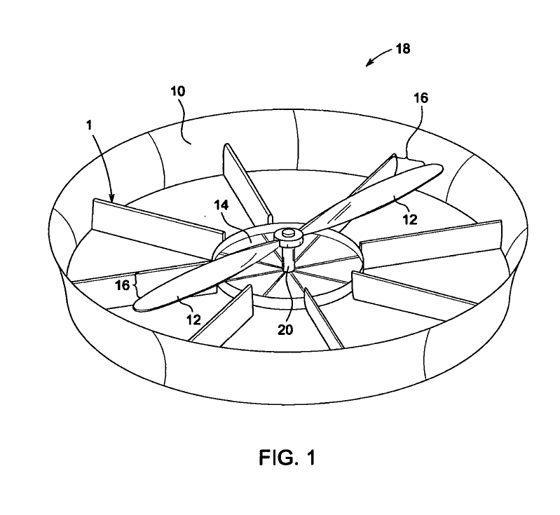

FIG. 1 is a top perspective view of a Torque Balanced, Lift rotor 12 Module Providing Increased Lift with Few or No Moving Parts, Assembly 18 consisting of a single Lift rotor 12 rigidly attached to a Lift rotor, drive mechanism 20, rotatably related to a Control mount 14, shown here in the preferred embodiment, as a drive shaft, centered in a relatively short, cylindrical, vertical, Duct 10, flared at the top, air entry end, closely fitted to the single Lift rotor 12 diameter of rotation for the attenuation of tip vortexes to increase lift, a fixed pitch, essentially vertical, Array of air foil shaped vanes 1 located below, and parallel to, the single Lift rotor 12, in the Lift rotor 12 rotor wash and Swirl air flow 16, attached to a Control mount 14 at the lengthwise end closest to a center point of the inside diameter of the relatively short, cylindrical, vertical, Duct 10, flared at the top, air entry end and attached at the other lengthwise end to the inside diameter of the short, cylindrical, vertical Duct 10, flared at the top, air entry end at, near, or beyond the bottom, air exit, end, a short vertical space below the single Lift rotor 12 and a Control mount 14 for attaching the Assembly 18 to a load, and the single Lift rotor 12 to a rotary torque generator through a Lift rotor, drive mechanism 20, and for allowing for control of tilt of the Torque Balanced, Lift rotor 12 Module, Providing Increased Lift With Few or No Moving Parts Assembly 18 independent of the load to be lifted by it. In the preferred embodiment the Control mount 14 is located in the center of the relatively short, cylindrical, vertical, Duct 10, but could be built into the Assembly 18 in other ways, such as having control surfaces as part of the relatively short, cylindrical, vertical, Duct 10, flared at the top, air entry end or the fixed pitch, essentially vertical, Array of air foil shaped vanes 1. In the preferred embodiment, the Control mount 14 in the center of the relatively short, cylindrical, vertical, Duct 10, flared at the top, air entry end could be raised or lowered for strength reasons or to provide proper positioning of the Lift rotor 12 or the Torque Balanced, Lift rotor 12 Module, Providing Increased Lift With Few or No Moving Parts Assembly 18. In the preferred embodiment, the single Lift rotor 12 of the Torque Balanced, Lift rotor 12 Module, Providing Increased Lift With Few or No Moving Parts Assembly 18 has two Lift rotor 12 blades, with air foil cross sections, but may have more than two blades. In the preferred embodiment, the single Lift rotor 12 blades are electronic, in flight, adjustable pitch, like lift rotors made by Ivoprop Incorporated, in California and set at a pitch to provide necessary lift being connected by its Lift rotor, drive mechanism 20 and turned by any rotary torque generator of the right capacity, such as a gasoline, internal combustion engine or an electric motor, for enough rotary torque generation and rounds per minute to accomplish its purpose. In the preferred embodiment the fixed pitch, essentially vertical, Array of air foil shaped vanes 1 are asymmetrical, but could be symmetrical air foil shapes. The relatively short, cylindrical, vertical Duct 10, flared at the top, air entry end inside diameter and the single Lift rotor 12 diameter of rotation within the relatively short, cylindrical, vertical Duct 10, flared at the top air entry end should be closely fitted thereby attenuating the lift rotor's tip vortexes, increasing lift and creating greater lift capacity. Attenuating the lift rotor's tip vortexes and increasing lift requires the lift rotor's plane of rotation to be positioned parallel to and below the relatively short, vertical, cylindrical Duct 10 flared opening at the top, air entry end and its diameter when rotating to be close to the inside diameter of the relatively short, cylindrical, vertical Duct 10, flared at the top, air entry end inside diameter through 360 degrees of rotation. The relatively short, cylindrical, vertical Duct 10, flared at the top, air entry end should be strong and rigid enough to dampen vibration and light weight for added net lift capacity, and rigid enough to maintain its cylindrical shape and positioning under the stresses of various air pressures and air flow from different directions to accomplish the purpose for which its shape and position is intended. These air pressures and air flows are a result of air being pulled into the top of the relatively, short, cylindrical, vertical Duct 10, flared air, entry end at the top, by the single Lift rotor 12 blades' low pressure top surface and by the single Lift rotor 12 blade high pressure bottom surface to generate lift at high revolutions per minute, up to 2,500 revolutions per minute for a 72″ diameter Lift rotor 12, and from the air pressures and air flows interaction with the relatively short, cylindrical, vertical Duct 10 flared at the top, air entry end inside and outside diameter while lifting a load and in horizontal flight or movement. Carbon fiber composite, or some other strong, lightweight material would be suitable for fabricating the relatively short, cylindrical, vertical Duct 10 with a flared air entry at the top, fixed pitch, essentially vertical, Array of air foil shaped vanes 1, and a center Control mount 14 all in one mold or formed together. The fixed pitch, essentially vertical, Array of air foil shaped vanes 1 should be attached or molded to the inside diameter of the relatively short, cylindrical, vertical Duct 10 flared at the top, air entry end at one lengthwise end and at the other lengthwise end to each other in the center or a center Control mount 14 as needed, with the fixed pitch, essentially vertical Array of air foil shaped vanes 1 with their leading edges extending upward, towards the single Lift rotor 12, rotor wash and Swirl air flow 16 component, and the trailing edges extending downward towards, at or below the duct's air exit, end in the preferred embodiment, but may be attached to themselves or some other fixture, as appropriate for the purpose, in the center of the relatively short, cylindrical, vertical Duct 10, flared at the top, air entry end diameter and just below the single Lift rotor 12. The fixed pitch, essentially vertical, Array of air foil shaped vanes 1 should have a degree of pitch in relation to the single Lift rotor 12 rotor wash and Swirl air flow 16 in order to create and balance anti-torque, lateral lift 360 degrees around the inside circumference of the relatively short, cylindrical, vertical Duct 10, flared at the top air entry end while impeding air flow and lift as little as possible, and can be sized and positioned in various ways to achieve this purpose. There is a Swirl air flow 16 component of rotor wash created beneath every rotary lift producing single Lift rotor 12 rotor blade caused by friction between the single Lift rotor 12 blade and the air in which it is turning and more particularly by the pitch of the single Lift rotor 12, rotor blade pulling air downward with its top, low pressure side, and pushing air down with its bottom, high pressure side, which is necessary for lift generation. The greater the pitch of a single Lift rotor 12 rotor blade, the greater the rotor wash and Swirl air flow 16 component beneath the single Lift rotor 12 rotor blade while producing rotary lift. The Swirl air flow 16 component of rotor blade rotor wash moves downward, away from the high pressure bottom side of the single Lift rotor 12 rotor blades and is drawn and pushed in the same rotational direction as the single Lift rotor 12 rotation. This Swirl air flow 16 component of Lift rotor 12 rotor wash is always present and is counter productive for lift generation to the degree it is a sideways air flow instead of a vertical, lift air flow. The Swirl air flow 16 component of a single Lift rotor 12 rotor blade rotor wash takes energy to generate and wastes part of it by not being straight line vertical lift. The present invention utilizes wasted swirl energy, by using a ducted air flow to cause the Swirl air flow 16 component of rotor wash and the rotor wash itself to interact with a fixed pitch, essentially vertical Array of air foil shaped vanes 1 to create anti-torque lateral lift, increasing overall efficiency of single rotor lifting methods using other methods of torque control, while continuously controlling and balancing 100% of the torque requirements of a single Lift rotor 12 with anti-torque lateral lift even while the torque requirements and loads are constantly varying. In the Torque Balanced, Lift rotor 12 Module Providing Increased Lift with Few or No Moving Parts Assembly 18 the Swirl air flow 16 component of rotor wash is forced by the relatively short, cylindrical, vertical Duct 10, flared at the top, air entry end to interact with the fixed, essentially vertical, Array of air foil shaped vanes 1 located down stream in the single Lift rotor 12 rotor wash, contained within the relatively short, cylindrical, vertical, Duct 10, flared at the top, air entry end by decreasing pressure on the fixed pitch, essentially vertical Array of air foil shaped vanes 1 low pressure side, facing the direction of the Lift rotor 12 rotation, and increasing pressure on the fixed pitch, essentially vertical Array of air foil shaped vanes 1 high pressure side, facing opposite the direction of the Lift rotor 12 rotation, thereby adding greatly to anti-torque, lateral lift creation and making it possible to balance and control the torque required by a single Lift rotor 12 very close to within it own diameter. In the preferred embodiment the single Lift rotor 12 with two rotor blades are pitched at 30″ of pitch and have a rotation diameter of 72″. The Lift rotor 12 is centered horizontally within the relatively short, cylindrical, vertical, Duct 10 inside diameter, with a plane of rotation parallel to and just below the flared top, air entry end of the relatively short, cylindrical, vertical, Duct 10 flared at the top, air entry end with an inside diameter of 73″ and a total height of about nine and one half inches. The fixed pitch, essentially vertical Array of air foil shaped vanes 1 have a cord of 6″, a homemade camber of three fourth of an inch, have an asymmetrical air foil cross section are 24″ long and positioned so their trailing edges ends on or about the same horizontal plane as the vertical Duct 10, flared at the top, air entry end, air exit end does and their leading edge extends upward to about one and one half inches below the parallel plane of the single Lift rotor 12 rotation and parallel to it with a 7 degree pitch angle from 90 degrees, leading edge being tilted towards the direction of the single Lift rotor 12 rotation. The asymmetrical, fixed pitch, essentially vertical Array of air foil shaped vanes 1 are positioned within the relatively short, cylindrical, vertical Duct 10, flared at the top, air entry end so their flatter air foil surface with the sharper portion of the leading edge on it, their high pressure surface, is facing opposite the direction of the single Lift rotor 12 rotation and their more rounded air foil surface, with the more rounded part of the leading edge is facing the same direction as the single Lift rotor 12 rotation. They are made of carbon fiber and molded, for rigid attachment, to the center Control mount 14 and to the inside diameter of the relatively short, cylindrical, vertical, Duct 10, flared at the top, air entry end. This preferred embodiment will continuously balance the torque required by a single Lift rotor 12 with anti-torque lateral lift with the same vertical center as the center of torque requirement for lift to lift up to eighty pounds with about ten horsepower with only trim adjustments. Trim adjustments may be accomplished by diverting some of the rotor wash or entry air, or extendable lift surfaces on the trailing edge of the fixed, essentially vertical Array of air foil shaped vanes 1 or stubby vanes attached to the inside or outside diameter of the short, cylindrical vertical Duct 10, flared at the top, air entry end, entry air vanes, or the shape of the load for example.

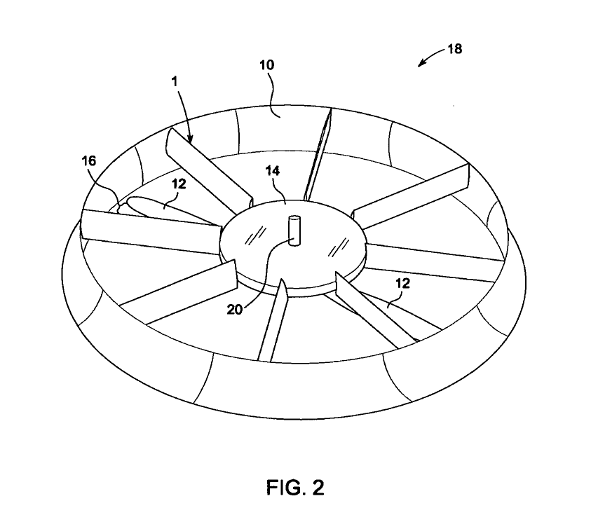

FIG. 2 Is a bottom perspective view of a Torque Balanced, Lift rotor 12 Module, Providing Increased Lift, with Few or No Moving Parts assembly 18 consisting of a swirl air flow 16 a duct 10 surrounding an array of air foil shaped vanes 1 beneath a lift rotor 12 driven by a lift rotor, drive mechanism 20 and attached to the inside diameter of the duct 10, flared at the top, air entry end below the lift rotor 12 and to a central control mount 14 at the other lengthwise end of each air foil.

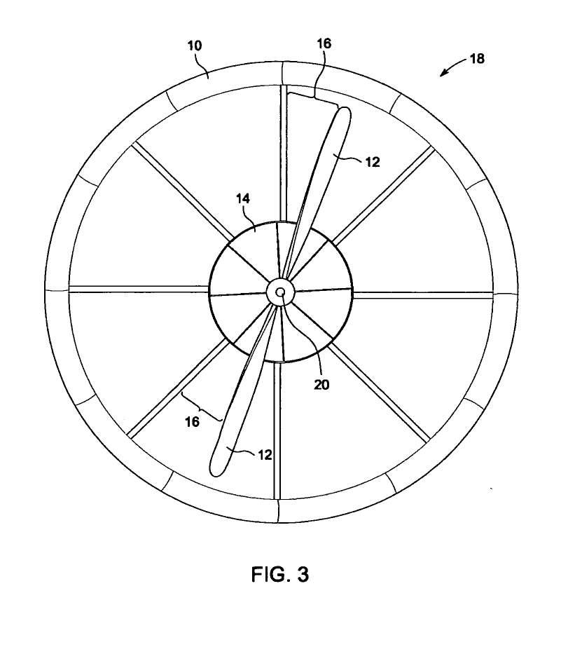

FIG. 3 is a top view of a Torque Balanced, Lift rotor 12 Module, Providing Increased Lift, with Few or No Moving Parts assembly 18 consisting of a swirl air flow 16 a duct 10 surrounding an array of air foil shaped vanes 1 beneath a lift rotor 12 driven by a lift rotor, drive mechanism 20 and attached to the inside diameter of the duct 10, flared at the top, air entry end below the lift rotor 12 and to a central control mount 14 at the other lengthwise end of each air foil.

In operation the single Lift rotor 12, attaches mechanically to a rotary torque generator through its Lift rotor, drive mechanism 20 and uses the rotary torque to produce increased lift over a single Lift rotor 12 without the rest of the Torque Balanced, Lift rotor 12 Module, Providing Increased Lift With Few or No Moving Parts Assembly 18 because of the technically optimal fit, less than plus or minus 0.5% of the single Lift rotor 12 diameter of rotation, centered in the relatively short, cylindrical, vertical, Duct 10 inside diameter around the single Lift rotor 12 horizontal plane of rotation and its placement parallel to and just below the relatively short, cylindrical, vertical, Duct 10, flared at the top air entry end. This open air in, ducted air out, type of the relatively short, cylindrical, vertical, Duct 10, flared at the top, air entry end, a type “B”, is effective for air drawn into the relatively short, cylindrical, vertical, Duct 10, flared at the top, air entry end by a single Lift rotor 12, for fast, strong, smooth, exit air flow, producing maximal lift. The fixed pitch, essentially vertical, Array of air foil shaped vanes 1, when properly sized and oriented, act as an automatic, torque balance of torque requirements of a single Lift rotor 12, mechanism under varying load weights and power settings. In effect, they react to changes in torque with an equal but opposite change in balanced, anti-torque lateral lift. Continuous torque balance is accomplished by load weight, lift generation, single Lift rotor 12 blade pitch and single Lift rotor 12 speed of rotation interacting with the fixed pitch, essentially vertical, Array of air foil shaped vanes 1 located below the single Lift rotor 12, single Lift rotor 12 located above the fixed pitch, essentially vertical Array of air foil shaped vanes 1 being located within the relatively short, cylindrical, vertical Duct 10. The relatively short, cylindrical, vertical, Duct 10 flared at the top, air entry end serves to lock the function of the single Lift rotor 12 together with the function of the fixed pitch, essentially vertical, Array of air foil shaped vanes 1 which causes torque balance to be achieved and to be continuous even during varying toad weights and torque power settings. The properties of the single Lift rotor 12, generated ducted air flow, are forced to interact with the properties of the fixed pitch, essentially vertical, Array of air foil shaped vanes 1 in a synchronized manner. When one changes, the other changes in an equal but opposite way.

When a relatively light load is lifted by a Torque Balanced, Lift rotor 12 Module, Providing Increased Lift With Few or No Moving Parts Assembly 18, a relatively small amount of torque is required to turn the Lift rotor 12, at a certain pitch setting, to lift the load, which generates a relatively weak rotor wash with Swirl air flow 16 component contained by the relatively short, cylindrical, vertical Duct 10, flared at the top, air entry end and forced to interact with the fixed pitch, essentially vertical Array of air foil shaped vanes 1 which generate a relatively small amount of anti-torque lateral lift and as a result, torque balance is achieved. When a heavier load is lifted by the same Torque Balanced, Lift rotor 12 Module, Providing Increased Lift With Few or No Moving Parts Assembly 18 relatively more torque is required to turn the Lift rotor 12 blades, set at the same pitch, sufficient rounds per minute to lift the heavier load which creates a relatively stronger Lift rotor 12, rotor wash with a relatively stronger Swirl air flow 16 component, which is forced by the relatively short, cylindrical, vertical Duct 10, flared at the top, air entry end to interact with the fixed pitch, essentially vertical Array of air foil shaped vanes 1 and generate relatively stronger anti-torque lateral lift which maintains torque balance, excluding trim adjustments. Trim adjustments may be accomplished by various means. The constant, linearly generated, interaction between the Lift rotor 12, lift and rotor wash with its Swirl air flow 16 component, contained by the relatively short, cylindrical, vertical, Duct 10, flared at the top, air entry end inside diameter and the shape and length of the fixed pitch, essentially vertical Array of air foil shaped vanes 1, creates a condition wherein every increase or decrease in torque applied to the single Lift rotor 12 creates an approximately equal but opposite anti-torque lateral lift response produce a Torque Balanced, Lift rotor 12 Module Providing Increased Lift with Few or No Moving Parts Assembly 18 capable of constant torque balance and rotational control of a load being lifted and flown or moved horizontally under changing load, weight and torque force inputs.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A torque balanced, lift rotor module, providing increased lift with few or no moving parts for continuous balance and control of the torque requirements and horizontal flight or movement of a single lift rotor lifting a load, using the single lift rotor rotor wash with swirl air flow component to create anti-torque, lateral lift, comprising:
means for creating lateral lift in an anti-torque rotational direction, evenly distributed, around the relatively short, cylindrical, vertical, duct inside diameter center point, utilizing the lift rotor's rotor wash and the rotor wash, swirl air flow component;
means for containing and controling the rotor wash with a swirl air flow component, causing them to interact with the fixed pitch, essentially vertical, array of air foil shaped vanes, greatly increasing lateral lift in an anti-torque rotational direction and increasing lift by closely fitting the lift rotor diameter or rotation thereby attenuating the single lift rotor's tip vortexes, rigidly connected to said means for creating lateral lift in an anti-torque rotational direction, evenly distributed, around the relatively short, cylindrical, vertical, duct inside diameter center point, utilizing the lift rotor's rotor wash and the rotor wash, swirl air flow component;
means for generating lift and rotor wash with a swirl air flow component below the lift rotor plane of rotation and mechanically connecting lift produced to a rotary torque generator and a load to be lifted by it;
means for attaching the torque balanced, lift rotor module, providing increased lift, with few or no moving parts, assembly to a load and the lift rotor drive mechanism to a rotary torque generator and providing control surfaces for tilting the torque balanced, lift rotor module, providing increased lift, with few or no moving parts, assembly without tilting the load, rotatably connected to said means for generating lift and rotor wash with a swirl air flow component below the lift rotor plane of rotation and mechanically connecting lift produced to a rotary torque generator and a load to be lifted by it, and rigidly connected to said means for creating lateral lift in an anti-torque rotational direction, evenly distributed, around the relatively short, cylindrical, vertical, duct inside diameter center point, utilizing the lift rotor's rotor wash and the rotor wash, swirl air flow component;
means for increasing pressure on the high pressure side, facing the opposite direction of the single lift rotor rotation, and decreasing pressure on the low pressure side, facing the same direction of the lift rotor rotation, of the fixed pitch, essentially vertical, array of air foil shaped vanes, located a short vertical space below the lift rotor, thus greatly increasing anti-torque lateral lift, angularly connected to said means for generating lift and rotor wash with a swirl air flow component below the lift rotor plane of rotation and mechanically connecting lift produced to a rotary torque generator and a load to be lifted by it, and angularly engaged to said means for creating lateral lift in an anti-torque rotational direction, evenly distributed, around the relatively short, cylindrical, vertical, duct inside diameter center point, utilizing the lift rotor's rotor wash and the rotor wash, swirl air flow component;
means for providing continuous torque balance of a single lift rotor lifting a load, attaching to a load, tilting independent of the load it is attached to and providing for connection of the lift rotor to a rotary torque generator, subassembly interconnected to said means for attaching the torque balanced, lift rotor module, providing increased lift, with few or no moving parts, assembly to a load and the lift rotor drive mechanism to a rotary torque generator and providing control surfaces for tilting the torque balanced, lift rotor module, providing increased lift, with few or no moving parts, assembly without tilting the load, subassembly interconnected to said means for generating lift and rotor wash with a swirl air flow component below the lift rotor plane of rotation and mechanically connecting lift produced to a rotary torque generator and a load to be lifted by it, subassembly interconnected to said means for containing and controling the rotor wash with a swirl air flow component, causing them to interact with the fixed pitch, essentially vertical, array of air foil shaped vanes, greatly increasing lateral lift in an anti-torque rotational direction and increasing lift by closely fitting the lift rotor diameter or rotation thereby attenuating the single lift rotor's tip vortexes, and subassembly interconnected to said means for creating lateral lift in an anti-torque rotational direction, evenly distributed, around the relatively short, cylindrical, vertical, duct inside diameter center point, utilizing the lift rotor's rotor wash and the rotor wash, swirl air flow component; and
means for transmitting rotary torque to the lift rotor and being driven by a rotary torque generator, subassembly interconnected to said means for providing continuous torque balance of a single lift rotor lifting a load, attaching to a load, tilting independent of the load it is attached to and providing for connection of the lift rotor to a rotary torque generator, and responsively connected to said means for generating lift and rotor wash with a swirl air flow component below the lift rotor plane of rotation and mechanically connecting lift produced to a rotary torque generator and a load to be lifted by it.

2. The torque balanced, lift rotor module, providing increased lift with few or no moving parts in accordance with claim 1, wherein said means for creating lateral lift in an anti-torque rotational direction, evenly distributed, around the relatively short, cylindrical, vertical, duct inside diameter center point, utilizing the lift rotor's rotor wash and the rotor wash, swirl air flow component comprises a fixed pitch, essentially vertical, air foil cross section, leading edge up towards the bottom, high pressure side of the single lift rotor, trailing edge down ending at, before or after, the duct's exit air end, arrayed around the center of the relatively short, vertical, cylindrical, duct with a flared air entry end at the top and attached near the bottom of the air exit end for 360 degree, balanced, lateral lift, anti-torque array of air foil shaped vanes.

3. The torque balanced, lift rotor module, providing increased lift with few or no moving parts in accordance with claim 1, wherein said means for containing and controling the rotor wash with a swirl air flow component, causing them to interact with the fixed pitch, essentially vertical, array of air foil shaped vanes, greatly increasing lateral lift in an anti-torque rotational direction and increasing lift by closely fitting the lift rotor diameter or rotation thereby attenuating the single lift rotor's tip vortexes comprises a short, cylindrical, vertical, flared at top, air entry end, sized to contain lift rotor's rotation and increase lift, inside diameter connected rigidly to the outer lengthwise ends of the array of air foil shaped vanes, oriented so air drawn in by the lift rotor enters its flared top and exits the bottom duct.

4. The torque balanced, lift rotor module, providing increased lift with few or no moving parts in accordance with claim 1, wherein said means for generating lift and rotor wash with a swirl air flow component below the lift rotor plane of rotation and mechanically connecting lift produced to a rotary torque generator and a load to be lifted by it comprises a two or more rotor blades with air foil cross sections, mechanically attached to and turned by a rotary torque generator, its plane of rotation parallel with the duct's flared air entry end and below it, creates swirl air flow and rotor wash lift rotor.

5. The torque balanced, lift rotor module, providing increased lift with few or no moving parts in accordance with claim 1, wherein said means for attaching the torque balanced, lift rotor module, providing increased lift, with few or no moving parts, assembly to a load and the lift rotor drive mechanism to a rotary torque generator and providing control surfaces for tilting the torque balanced, lift rotor module, providing increased lift, with few or no moving parts, assembly without tilting the load comprises a connection surfaces for connection to inner lengthwise end of fixed pitch, essentially vertical, array of air foil shaped vanes, control surfaces for tilting the assembly control mount.

6. The torque balanced, lift rotor module, providing increased lift with few or no moving parts in accordance with claim 1, wherein said means for increasing pressure on the high pressure side, facing the opposite direction of the single lift rotor rotation, and decreasing pressure on the low pressure side, facing the same direction of the lift rotor rotation, of the fixed pitch, essentially vertical, array of air foil shaped vanes, located a short vertical space below the lift rotor, thus greatly increasing anti-torque lateral lift comprises a created by a single lift rotor lifting a load, component of rotor wash, moves downward, away from the bottom, high prressure side of the single lift rotor, and in the same rotational direction, interacts with the fixed pitch, essentially vertical, array of air foil shaped vanes swirl air flow.

7. The torque balanced, lift rotor module, providing increased lift with few or no moving parts in accordance with claim 1, wherein said means for providing continuous torque balance of a single lift rotor lifting a load, attaching to a load, tilting independent of the load it is attached to and providing for connection of the lift rotor to a rotary torque generator comprises a duct, flared at the top, air entry end, single lift rotor, fixed pitch, essentially vertical array of air foil shaped vanes, control mount, lift rotor drive mechanism assembly.

8. The torque balanced, lift rotor module, providing increased lift with few or no moving parts in accordance with claim 1, wherein said means for transmitting rotary torque to the lift rotor and being driven by a rotary torque generator comprises a transmits rotary torque to the lift rotor, driven by a rotary torque generator lift rotor, drive mechanism.

9. A torque balanced, lift rotor module, providing increased lift with few or no moving parts for continuous balance and control of the torque requirements and horizontal flight or movement of a single lift rotor lifting a load, using the single lift rotor rotor wash with swirl air flow component to create anti-torque, lateral lift, comprising:
a fixed pitch, essentially vertical, air foil cross section, leading edge up towards the bottom, high pressure side of the single lift rotor, trailing edge down ending at, before or after, the duct's exit air end, arrayed around the center of the relatively short, vertical, cylindrical, duct with a flared air entry end at the top and attached near the bottom of the air exit end for 360 degree, balanced, lateral lift, anti-torque array of air foil shaped vanes, for creating lateral lift in an anti-torque rotational direction, evenly distributed, around the relatively short, cylindrical, vertical, duct inside diameter center point, utilizing the lift rotor's rotor wash and the rotor wash, swirl air flow component;
a short, cylindrical, vertical, flared at top, air entry end, sized to contain lift rotor's rotation and increase lift, inside diameter connected rigidly to the outer lengthwise ends of the array of air foil shaped vanes, oriented so air drawn in by the lift rotor enters its flared top and exits the bottom duct, for containing and controling the rotor wash with a swirl air flow component, causing them to interact with the fixed pitch, essentially vertical, array of air foil shaped vanes, greatly increasing lateral lift in an anti-torque rotational direction and increasing lift by closely fitting the lift rotor diameter or rotation thereby attenuating the single lift rotor's tip vortexes, rigidly connected to said array of air foil shaped vanes;
a two or more rotor blades with air foil cross sections, mechanically attached to and turned by a rotary torque generator, its plane of rotation parallel with the duct's flared air entry end and below it, creates swirl air flow and rotor wash lift rotor, for generating lift and rotor wash with a swirl air flow component below the lift rotor plane of rotation and mechanically connecting lift produced to a rotary torque generator and a load to be lifted by it;
a connection surfaces for connection to inner lengthwise end of fixed pitch, essentially vertical, array of air foil shaped vanes, control surfaces for tilting the assembly control mount, for attaching the torque balanced, lift rotor module, providing increased lift, with few or no moving parts, assembly to a load and the lift rotor drive mechanism to a rotary torque generator and providing control surfaces for tilting the torque balanced, lift rotor module, providing increased lift, with few or no moving parts, assembly without tilting the load, rotatably connected to said lift rotor, and rigidly connected to said array of air foil shaped vanes;
a created by a single lift rotor lifting a load, component of rotor wash, moves downward, away from the bottom, high prressure side of the single lift rotor, and in the same rotational direction, interacts with the fixed pitch, essentially vertical, array of air foil shaped vanes swirl air flow, for increasing pressure on the high pressure side, facing the opposite direction of the single lift rotor rotation, and decreasing pressure on the low pressure side, facing the same direction of the lift rotor rotation, of the fixed pitch, essentially vertical, array of air foil shaped vanes, located a short vertical space below the lift rotor, thus greatly increasing anti-torque lateral lift, angularly connected to said lift rotor, and angularly engaged to said array of air foil shaped vanes;
a duct, flared at the top, air entry end, single lift rotor, fixed pitch, essentially vertical array of air foil shaped vanes, control mount, lift rotor drive mechanism assembly, for providing continuous torque balance of a single lift rotor lifting a load, attaching to a load, tilting independent of the load it is attached to and providing for connection of the lift rotor to a rotary torque generator, subassembly interconnected to said control mount, subassembly interconnected to said lift rotor, subassembly interconnected to said duct, and subassembly interconnected to said array of air foil shaped vanes; and
a transmits rotary torque to the lift rotor, driven by a rotary torque generator lift rotor, drive mechanism, for transmitting rotary torque to the lift rotor and being driven by a rotary torque generator, subassembly interconnected to said assembly, and responsively connected to said lift rotor.

10. A torque balanced, lift rotor module, providing increased lift with few or no moving parts for continuous balance and control of the torque requirements and horizontal flight or movement of a single lift rotor lifting a load, using the single lift rotor rotor wash with swirl air flow component to create anti-torque, lateral lift, comprising:
a fixed pitch, essentially vertical, air foil cross section, leading edge up towards the bottom, high pressure side of the single lift rotor, trailing edge down ending at, before or after, the duct's exit air end, arrayed around the center of the relatively short, vertical, cylindrical, duct with a flared air entry end at the top and attached near the bottom of the air exit end for 360 degree, balanced, lateral lift, anti-torque array of air foil shaped vanes, for creating lateral lift in an anti-torque rotational direction, evenly distributed, around the relatively short, cylindrical, vertical, duct inside diameter center point, utilizing the lift rotor's rotor wash and the rotor wash, swirl air flow component;
a short, cylindrical, vertical, flared at top, air entry end, sized to contain lift rotor's rotation and increase lift, inside diameter connected rigidly to the outer lengthwise ends of the array of air foil shaped vanes, oriented so air drawn in by the lift rotor enters its flared top and exits the bottom duct, for containing and controling the rotor wash with a swirl air flow component, causing them to interact with the fixed pitch, essentially vertical, array of air foil shaped vanes, greatly increasing lateral lift in an anti-torque rotational direction and increasing lift by closely fitting the lift rotor diameter or rotation thereby attenuating the single lift rotor's tip vortexes, rigidly connected to said array of air foil shaped vanes;
a two or more rotor blades with air foil cross sections, mechanically attached to and turned by a rotary torque generator, its plane of rotation parallel with the duct's flared air entry end and below it, creates swirl air flow and rotor wash lift rotor, for generating lift and rotor wash with a swirl air flow component below the lift rotor plane of rotation and mechanically connecting lift produced to a rotary torque generator and a load to be lifted by it;
a connection surfaces for connection to inner lengthwise end of fixed pitch, essentially vertical, array of air foil shaped vanes, control surfaces for tilting the assembly control mount, for attaching the torque balanced, lift rotor module, providing increased lift, with few or no moving parts, assembly to a load and the lift rotor drive mechanism to a rotary torque generator and providing control surfaces for tilting the torque balanced, lift rotor module, providing increased lift, with few or no moving parts, assembly without tilting the load, rotatably connected to said lift rotor, and rigidly connected to said array of air foil shaped vanes;
a created by a single lift rotor lifting a load, component of rotor wash, moves downward, away from the bottom, high prressure side of the single lift rotor, and in the same rotational direction, interacts with the fixed pitch, essentially vertical, array of air foil shaped vanes swirl air flow, for increasing pressure on the high pressure side, facing the opposite direction of the single lift rotor rotation, and decreasing pressure on the low pressure side, facing the same direction of the lift rotor rotation, of the fixed pitch, essentially vertical, array of air foil shaped vanes, located a short vertical space below the lift rotor, thus greatly increasing anti-torque lateral lift, angularly connected to said lift rotor, and angularly engaged to said array of air foil shaped vanes;
a duct, flared at the top, air entry end, single lift rotor, fixed pitch, essentially vertical array of air foil shaped vanes, control mount, lift rotor drive mechanism assembly, for providing continuous torque balance of a single lift rotor lifting a load, attaching to a load, tilting independent of the load it is attached to and providing for connection of the lift rotor to a rotary torque generator, subassembly interconnected to said control mount, subassembly interconnected to said lift rotor, subassembly interconnected to said duct, and subassembly interconnected to said array of air foil shaped vanes; and
a transmits rotary torque to the lift rotor, driven by a rotary torque generator lift rotor, drive mechanism, for transmitting rotary torque to the lift rotor and being driven by a rotary torque generator, subassembly interconnected to said assembly, and responsively connected to said lift rotor.
